(19) United States
(12) Patent Application Publication
(10) Pub. No.: US 2021/0144297 A1
(43) Pub. Date: May 13, 2021

(54) Methods System and Device for Safe-Selfie

(71) Applicant: Shawn Glidden, Raleigh, NC (US)

(72) Inventor: Shawn Glidden, Raleigh, NC (US)

(21) Appl. No.: 17/095,607

(22) Filed: Nov. 11, 2020

Related U.S. Application Data
(60) Provisional application No. 62/934,499, filed on Nov. 12, 2019.

(51) Int. Cl. H04N 5/232

(52) U.S. Cl. CPC H04N 5/23219; H04N 5/23222; H04N 5/232935

(57) ABSTRACT

An improved system, method and device are provided to improve the safe use mobile or portable electronic devices. More particularly, methods, systems and devices are provided that provide and project a user self-image from a first camera onto an image captured by a second camera having a different orientation from the first camera, thereby creating a selfie via image overlay and enhancing the safety of the user.

### TECHNICAL FIELD

The present invention is directed to improved self-image data capture methods, systems and devices. More particularly, the present invention provides for image data overlay from an image in one camera onto an image captured by another camera, and thereby, projecting a user's self-image onto a foreground rather than capturing a user's self-image in front of a background.

### BACKGROUND

An astonishing number of hand-held smart phones are currently in use today. It is estimated over 2.5 billion smart phones are currently in use round the world, mostly likely each having at least one camera. Likewise, it is estimated there are around 2 billion users of social media applications such as Facebook and the like. Other social media companies report astonishing numbers of daily users taking and sharing photographs from their handheld, mobile devices; for example, Instagram reports roughly 400 million daily users and Snapchat reports roughly 200 million daily users. Not surprising, these numbers confirm what is evident in everyday life—modern individuals are infatuated with social media and the ability to real-time share one's life and environmental conditions with friends, family and general followers.

A self-image, or selfies, are a popular way to capture or memorialize an event or moment. For example, a selfie can be defined as an image that a user of an image capturing device (e.g., a camera) captures using the image capturing device where the subject of the image includes the user. Typically, when taking or capturing a self-image, the user holds a computing device (e.g., smartphone, tablet computer, etc.) having a forward facing image sensor in close proximity to the user by holding the computing device at arm's length to capture an image of the user with the forward facing image sensor.

Unfortunately, along with these volumes of uses and the user's infatuation with social medial posting, exchange and ratings or “likes”, society is seeing more and more accidents and devastating injuries resulting from daring, outrageous and/or simply careless or reckless self-images. For example, there has been an increase in reported deaths and devastating injuries resulting from falls and other accidents during users taking photographs of themselves, a selfie, with the desire to report via photographic evidence of their association with a geographic location or event, some of which put the user in compromising, dangerous or reckless positions. For further example, there are reports of individuals hanging out of moving train windows, standing on the top or very edge of a tall structure, building or natural outcropping, standing very close to moving objects and the like to capture a selfie that will gain social media attention. Importantly, selfies are generally taken with the users back to their desired image, which makes the selfie even more dangerous. Many of these selfie stunts have unfortunately gone wrong and resulted in deaths and severe accidents.

The present invention overcomes these risks and dangers taken by users of mobile electronic devices in producing selfie images and provides other benefits as will become clearer to those skilled in the art from the foregoing description.

### SUMMARY

The invention includes methods, systems and apparatus for capturing a plurality of visually perceptible elements from multiple cameras, identifying a source of a user's self-image and overlaying that self-image onto data of another field of an image in view of a second camera to enhance safety of a user during self-imaging.

Upon particular activation of a first camera, the image to be captured by the first camera is associated with a user's face recognized by the device or by a depth determined by the device and displayed on an image display while an image to be captured by the second camera is underlaid to the image of the first camera, thereby generating a selfie of the user safely facing the background in the selfie as foreground in real life.

### BRIEF DESCRIPTION OF THF DRAWINGS

FIGS. 1A and 1B illustrate a user side and an opposite side of an embodiment of a device according to the present invention;

FIG. 2 shows an embodiment of the present invention with a desired image displayed on a display screen of a device;

FIG. 3 shows an image of a virtual selfie according to an embodiment of the present invention;

FIG. 4 shows certain processing instructions of a virtual selfie application of the present invention;

FIG. 5 shows certain other processing instructions of a virtual selfie application of the present invention; and

FIG. 6 shows another embodiment for processing a self image into a desired image according to the present invention.

### DETAILED DESCRIPTION OF THE INVENTION

Self imaging, or taking a selfie, and sharing that selfie through mobile social media devices and systems is important to many individuals in modern society. Many devices, such as for example, mobile phones, laptops, tablets, watches and other electronic devices are capable of capturing image data and transmitting and/or receiving image data to and from other computing sources, such as for example cloud and/or internet based media resources. Many advancements have been made to the hardware, camera technology, and software for processing, storing and managing image data, some of where are included in the following patent literature, including but not limited to U.S. Published Applications: 20190102924 titled Generating Synthetic Group Selfies; 20180191651 titled Techniques for Augmenting Shared Items in Messages; 20190005722 titled Device Panel Capabilities and Spatial Relationships; 29160105604 titled Method and Mobile to Obtain an Image Aligned with a Reference Image; 20180255237 titled Method and Application for Aiding Self Photography; and U.S. Pat. Nos.: 7,102,686 titled Image-capturing Apparatus Having Multiple Image Capturing Units; 8,081,230 titled Image Capturing Device Capable of Guiding User to Capture Image Comprising Himself and Guiding Method Thereof; 8,957,981 titled Imaging Device for Capturing Self-portrait Images, each of which are incorporated herein by reference in their entirety.

A selfie can be defined as an image that a user of an image capturing device (e.g., a camera, a phone, a tablet, or the like) captures using the image capturing device where the subject of the image includes the user. Typically, when taking or capturing a selfie, the user holds a computing device (e.g., smartphone, tablet computer, etc.) having a forward facing image sensor (or camera) in close proximity to the user by holding the computing device at arm's length to capture an image of the user with the forward facing image sensor. In some cases, the user will use a device (e.g., a selfie stick) to extend the range of the user's arm so that the forward facing image capturing sensor can capture a wider image. The selfie is often of the user's face or a portion of the user's body (e.g., upper body) and any background visible behind the user, where the background is often a desired image that the user desires to be captured in front of and seen associated with.

It will be appreciated by one of ordinary skill in the art of smartphone, tablet or the like device usage, in particular such a device with a camera, that many users utilize the camera on such devices to take self-images whereby the user is self positioned in front of a desired background scene. The background scenes are called “background” or “desired image” as they are positioned behind the user as the user orients oneself to take a self-image in front of such background, or otherwise known as a “selfie”. Typically, one finds a background scenery for a potential selfie by seeing that scene as something in their real-life foreground. As it will be appreciated by one of ordinary skill in the art, the foreground/background orientation reference in this invention are important to the selfie user safety. When one typically approaches a foreground, or the landscape in front of oneself, the typical human senses, awareness, depth of field, and other sensory perceptions provide inputs processed to keep one safe, balanced and generally in control of their physical being. However, while conducting a selfie, a user of a device will typically position themselves between the device and their former foreground, now the background, i.e., placing their backs to the desired scene and outside one's typical senses and awareness. Because users typically seek selfies in memorable, daring, risky or unique situations to capture a social media user's attention or admiration, positioning many intended selfie landscapes to one's background invites danger and risks injury and even death. Accordingly, one of ordinary skill in the art will recognize the present invention, in summary, utilizes both a forward and reward facing camera of a device to capture an image of the user while the user keeps the landscape safely in their foreground but overlays that image of the user, captured by the user facing camera, on a desired image captured by the camera facing the desired field of view, i.e., same field of view as the user, thus overlaying a self image of the user over the desired image which the user desires to have as a background to their selfie.

A typical embodiment of the present invention will include a mobile device, such as a smartphone, tablet or the like, that includes at least two cameras, a computing processor associated with the cameras for operating the cameras and processing the image captured by the camera lens, a display screen for displaying the images of the cameras and interacting with the user, and optionally a communication processor for communicating across cellular or other transmittal approaches. The processor performs, for example, the tasks of processing the images captured by the cameras, storing the captured image data, providing the image data to the display screen for the user, determining which image data from which camera to display on the display screen and which image data to overlay on top of or in the foreground of image data from the other camera.

FIG. 1A and 1B show a computing device 100 having a user side 200 that includes a first camera 202 and a display screen 204. Display screen 204 can be used to display an image, such as a self image 210, captured by camera 202. FIG. 1 B shows another side 300 of computing device 100, where the other side 300 (also described as a forward facing side 300) includes another camera 302. In a preferred embodiment, the other side or forward facing side 300 of computing device 100 is located on an opposite side to the user facing side 200 such that second camera 302 faces away from the first camera 202. Computing device 100 also includes a processor, including instruction for processing images, a memory for saving the instructions, the images and other processings and operating information, as well as interfacing with the user and operating the cameras and display screen. In a preferred embodiment the duties of the processor are split among the multiple cameras 202 (FIG. 1A) and 302 (FIG. 1B) of the device 100. The image data in the field of cameras 202 and 302 may be processed through the processor for display on screen 204 for interfacing with a user. The processing of image data from cameras 202 and 302 can be simultaneous or virtually simultaneous from the users perspective such that both cameras 202 and 302 are in use at the same time and each, or certain portions of each cameras image data, is displayed on the screen together. The processor also includes instructions for interfacing with the user and processes image date as manipulated by user, such as selecting and moving self image onto the main image data, manipulating image data lightening, tone, tint, shade, color balance, hue, saturation, luminosity, and other necessary image data to match and merge image data captured from two cameras into a single, seamless and natural looking combined final image.

For reference purposes of the disclosure, the user side 200 is not restricted to solely facing the user, however it will be appreciated that nothing in this description is intended to limit device 100 or a user from turning device 100 such that the forward facing side 300 can face the user and the user facing side 200 faces away from the user.

Continuing with the description, FIG. 2 shows the user side 200 of device 100 with an image 212 on display screen 204 where image 212 is captured by the second camera 302. FIG. 2 also show orientation arrow showing user's field of view, where a user facing user side 200 will be looking at display screen 204 while also facing the scenery user is intending to capture with second camera 302, otherwise called herein for purposes of this description the desired image.

FIG. 3 shows a preferred embodiment of the present invention where a user facing the user facing side 200 of device 100 is captured in a self image 210 by camera 202 while second camera 302 captures a desired image 212 as the user keeps the scenery for the desired image in the foreground of user (as opposed to previously the user would have the desired image to their back while attempting to take a selfie). Processor of device 100 executes instructions to overlay or otherwise incorporate image data of self image 210 into image data of desired image 212 to make virtual selfie 211.

Cameras 202 and 302 can capture still images, stored video images, and/or live streaming video images. Each of these types of images (e.g., still images, stored video images, live streaming video images, etc.) can be used to generate the desired images and selfies described herein.

In some implementations, user device 100 can generate depth data for images captured by cameras 202 and 302. For example, user device can calculate depth data representing the distance between the camera and objects captured in an image. The depth data, or in other words a measure of distance, can be calculated per image pixel and can be stored as metadata for the images captured by cameras. Thus, when an image editing application processes the image, the image processing application can distinguish between foreground objects that are nearer cameras and background objects that are farther away from cameras. Different technologies can be implemented on user device 100 to capture or generate depth information for captured images. As another example, user device 100 can include a depth sensor 203, 303, whereby depth sensor can, for example, include a laser ranging system (e.g., LIDAR, laser range finder, etc.) that can calculate the distance between user device 100 cameras 202 and/or 302 and an object captured by the camera.

In some implementations, user device 100 can include a media database. For example, media database can store media, such as images captured by cameras 202 and/or 302, video images, individual selfies, background images, or the like, and media metadata (e.g., image location information, image depth data, etc.) captured and/or received by user device 100. For example, when virtual selfie application 400 uses cameras 202 and/or 302, depth sensors 203, 303 to capture images and/or image metadata, virtual selfie application 400 can store the images and/or image metadata in media database.

In some implementations, user device 100 can also include a communication application, such as a messaging application (e.g., text message application, instant message application, email application, etc.) used to distribute text and/or media (e.g., virtual selfies, individual selfies, desired images, etc.) to other user devices. Communication application can be a social media application that can be used by the user of user device 100 to upload and distribute virtual selfies through social media service running on typical server devices.

The present invention includes a graphical user interface for initiating a virtual selfie of the present invention. For example, graphical user interface (GUI) can be a GUI presented by virtual selfie application 400 on display 204 of user device 100. In some embodiments, GUI can be presented when virtual selfie application 400 is invoked on user device 100 by a user.

In some embodiments, GUI can present graphical user interface elements for capturing images using cameras 202 and/or 302. For example, GUI can include an image preview of an image to be captured by one or both of cameras 202 and/or 302 on user device 100. The image preview presented by GUI can act similarly to a view finder of an analog camera that allows the user to frame an image to be captured. Cameras 202 and/or 302 can, for example, provide a live feed of the images that the camera is receiving and present the live feed to screen 204 so that the user can capture and/or store either one of or both of the selfie image 210, desired image 212 or virtual selfie 214.

GUI can include image type selectors such that a user can select to store the image or video images for virtual selfie. The user can select to indicate that user device 100 should capture photo or copy/paste photos. When the user is ready to capture the video or still image, the user can select graphical element on screen 204 to capture the still image or initiate recording the video images.

In some embodiments, GUI can include graphical element for user to initiate virtual selfie mode of virtual selfie application 400. For example, in response to receiving a user selection of graphical element, virtual selfie application 400 can enter a virtual selfie mode and present one or more graphical user interfaces for creating a virtual selfie by operating cameras 202 and/or 302, depth sensors 203, 303, and manipulating image data according to the present invention.

In a preferred embodiment of the present invention user device 100 would remove the background portion of the selfie obtained by user facing camera 202 before combining such image data with the desired image 212 obtained by second camera 302 to generate the virtual selfie 214. Accordingly, depth sensor 203 can read self image 210 from user facing camera 202 and identify the user from depth sensor 203 or facial recognition application analysis of the image and/or depth sensor working in concert with facial recognition, to capture the user from the image captured by user facing camera 202 and remove such from the image to bring only the user from selfie image 210 into virtual selfie 214.

In some embodiments, the selfie image captured by camera 202 can include a foreground portion (e.g., corresponding to the image of the person captured in the image or the object closest to the camera) and a background portion (e.g., corresponding to objects behind the person or object captured in the image). Processor of device 100 can determine the foreground from the background portions of the image based on the depth data generated for the captured image, depth sensor and/or facial recognition processing. Objects (e.g., people) in the foreground may have smaller values for the depth data. Objects (e.g., trees) in the background may have larger values for the depth data. Device 100 can use the depth values to distinguish between foreground and background objects in the image and identify foreground and background portions of the image corresponding to the captured objects. Device 100 can also then modify the image (e.g., the individual selfie) to preserve the foreground portion of the image (e.g., the person) while removing the background portion of the image. Thus, the individual selfie image can be sent or transferred to the desired image data captured by camera 302 such that the selfie image input into desired image data may only include the individual person who was in the foreground when the individual selfie was captured.

According to an embodiment, an example of virtual selfie composition technique of the present invention includes, for example, virtual selfies generated by overlaying layers of individual selfie over desired image. Continuing the example above, the first camera 202 of device 100 acquires selfie 210 of the user (or a group associated with the user). The desired image 212 can be obtained from the second camera 302 and the images can be positioned at a different layers by processor and applications of device 100. For example, a user selfie 210 can be at the top most (e.g., closest to the viewing user) layer of image data and the background image, or the desired image 212 can be at a lower layer furthest from the viewing user and thus represent the user image 210 is actually in the virtual selfie 214 instead the virtual selfie 214 appearing like a copy/past input. When the images are combined to generate the virtual selfie 214, it will appear that the user is positioned in the foreground of the desired image 212 as though the user actually took a selfie with a single image captured by second camera 302. As will be appreciated with the present invention, the safety of the user is increased because the user did not position their back to the desired image scenery and risk injury to obtain the desired selfie through use of the single camera 302, but rather the user remained with the desired image in their foreground field of view while capturing the virtual selfie through use of both cameras 202, to capture the user, and second camera 302, to capture the desired image and allow the processing instructions of device 100 to form the desired selfie as virtual selfie 214.

As will be appreciated by one skilled in the art, graphical user interface for editing a virtual selfie can present on a display of user device 100 for editing or otherwise manipulating virtual selfie 214. To edit, arrange or rearrange the selfie within the desired image to generate the virtual selfie, the user can provide touch input dragging an individual selfie to a new position within the desired image. For example, the user can touch the individual selfie image 210 and drag it in the virtual selfie image to reveal more of the desired image 212 captured by second camera 302 and/or to place individual selfie with relation to components of the desired image to generate the effect desired by the user. The user can reposition an individual selfie anywhere within the desired image using this select and drag input.

Processing instructions can determine visual component or characteristic presentation size, tone, shade and other typical photographic aspects of the individual selfies based on the size, tone, shade, etc. of the desired background image. Virtual selfie application can scale the individual selfies based on the determined presentation size. For example, virtual selfie application 400 can scale the individual selfie so that it is about the same relative size as would be typical for a selfie, calculated based on a distance measured from device 100 to the user relative to the distance from device 100 to background of desired image. In alternative embodiments, a relative size difference of a user in a typical selfie to background can be calculated, or a table of relative size differences between distance to user compared to distance to desired image background and the virtual selfie application can automatically adjust the relative sizes and/or allow user to adjust the size of either image with touch, drag, expand, or shrink features.

According to other embodiments disclosed herein, as exampled in FIG. 4, processing executing virtual selfie application 400 of the present invention can also identify an imaged object of interest, such as self image 210 in a first image (410). The processor and application 400 defines an image frame that represents the outer boundaries of the self image 210. The processor and applications may examine the reference image to identify one or more groups of pixels or other portions of the image that represent the same object. In the illustrated example, the processor and applications may determine that the pixels representative of the face of the user and/or body of the user by determining the image object has sufficiently similar characteristics to be grouped together. Thus, the processor and/or applications can then select the identified data of the self image 210 image data (420) modify or adjust the image properties of that selected portion of self image data 210 (430), and apply that identified self image portion of the self image 210 image to the desired image 212 to make virtual selfie 214 (440), and capture desired image (450). Image properties to be adjusted or modified, by the processor and/or applications and/or by the user, include but are not limited to manipulating image data lightening, tone, tint, shade, color balance, hue, saturation, luminosity, and other necessary image data to match and/or merge multiple image data captured from two cameras into a single, seamless and natural looking combined final image.

In one embodiment as shown in FIG. 5, the processor executing virtual selfie application 400 can examine visual components of the desired image and/or selfie image data to determine which portions of the images represent the same imaged aspects, such as tone, shade, lightness, darkness, etc. (510) and adjust each (520) such that the self image from camera 202 appears to have been taken under the same conditions, at the same time as the desired image 204 from second camera 302 when self image 210 is overlaid into desired image 212 (530) and therefore virtual selfie 214 appears to be an actual selfie image. These visual components or characteristics sensed and/or adjusted can include, but are not limited to, the colors, intensities, luminance, or other visual characteristics of pixels in the image and/or image data. The pixels that have the same or similar characteristics (e.g., the pixels having visual characteristics with values that are within a designated range of each other, such as 1%, 5%, 10%, or another percentage or fraction) and that are within a designated distance of one or more other pixels having the same or similar visual components or characteristics in the image and/or image data (e.g., within a distance that encompasses no more than 1%, 5%, 10%, or another percentage or fraction of the field of view of the respective camera (e.g., image data from camera 202 compared with image data from camera 302), may be grouped together and identified as being representative of the same object. For example, a first pixel having a first color or intensity (e.g., associated with a color having a wavelength of 0.7 .mu.m) and a second pixel having a second color or intensity that is within a designated range of the first color or intensity (e.g., within 1%, 5%, 10%, or another value of 0.7 .mu.m) may be grouped together as being representative of the same object if the first and second pixels are within the designated range of each other. Optionally, several pixels may be grouped together if the pixels are within the designated range of each other. Those pixels that are in the same group may be designated as representing an object in the reference image and/or the image data. After adjusting image data, user captures desired image with adjusted self image Captured therein, at 540.

This disclosure herein describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones for application of the present invention. One or more of these electronic devices can include a touch-sensitive surface, such as screen 204. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

As will be appreciated by one of ordinary skill in the art, computing device 100 can implement the features and processes of FIGS. 1-5. The computing device 100 can include a memory interface, one or more data processors, image processors and/or central processing units, and a user interface. The memory interface, the one or more processors and/or the peripherals interface can be separate components or can be integrated in one or more integrated circuits. The various components in the computing device 100 can be coupled by one or more communication buses or signal lines.

Sensors, devices, and subsystems can be coupled to the peripherals interface to facilitate multiple functionalities for device 100, as otherwise shown in FIGS. 1-5. For example, a motion sensor, a light sensor, and a proximity sensor can be coupled to the peripherals interface to facilitate orientation, lighting, and proximity functions. Other sensors can also be connected to the peripherals interface, such as a global navigation satellite system (GNSS) (e.g., GPS receiver), a temperature sensor, a biometric sensor, magnetometer or other sensing device, to facilitate related functionalities.

A typical camera subsystem and an optical sensor, e.g., a charged coupled device (CCD) or a complementary metal-oxide semiconductor (CMOS) optical sensor, can be utilized to facilitate camera functions, such as recording photographs and video clips. The camera subsystem and the optical sensor can be used to collect images of a user e.g., for performing facial recognition analysis discussed elsewhere herein.

Communication functions of device 100 can be facilitated through one or more wireless communication subsystems, which can include radio frequency receivers and transmitters and/or optical (e.g., infrared) receivers and transmitters. The specific design and implementation of the communication subsystem can depend on the communication network(s) over which the computing device 100 is intended to operate or which environment it finds itself in from time to time, as will be appreciated by one of ordinary skill in the art. For example, the computing device 100 can include communication subsystems designed to operate over a GSM network, a GPRS network, an EDGE network, a Wi-Fi or WiMax network, and a Bluetooth™ network.

An audio subsystem can be coupled to a speaker and a microphone to facilitate voice-enabled functions, such as speaker recognition, voice replication, digital recording, and telephony functions. The audio subsystem can be configured to facilitate processing voice commands to initiate and/or execute virtual selfie application 400.

As will also be appreciated by one of ordinary skill in the art, the computing device 100 can present recorded audio and/or video files, such as MP3, AAC, and MPEG files. In some implementations, the computing device 100 can include the functionality of an MP3 player.

The memory interface can be coupled to the memory of device 100. The memory can include high-speed random access memory and/or non-volatile memory, such as one or more magnetic disk storage devices, one or more optical storage devices, and/or flash memory (e.g., NAND, NOR). The memory can store an operating system, such as Darwin, RTXC, LINUX, UNIX, OS X, WINDOWS, or an embedded operating system such as VxWorks.

The operating system can include instructions for handling basic system services and for performing hardware dependent tasks, as well as executing virtual selfie application 400. In some implementations, the operating system can be a kernel (e.g., UNIX kernel). In some implementations, the operating system can include instructions for performing voice authentication. For example, operating system can implement the virtual selfie features as described with reference to FIGS. 1-5.

As typical with modern devices, such as device 100, the memory can also store communication instructions to facilitate communicating with one or more additional devices, one or more computers and/or one or more servers. The memory can include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GNSS/Navigation instructions to facilitate GNSS and navigation-related processes and instructions; and/or camera instructions to facilitate camera-related processes and functions.

The memory can also store other software instructions to facilitate other processes and functions, such as the virtual selfie application processes 400 and functions as de3cribed with reference to FIGS. 1 6.

In a preferred embodiment of the present invention, as depicted in FIG. 6, virtual selfie application 400 executes instructions to operate user facing camera 202 simultaneously or virtually simultaneous to the user, and desired image facing camera 302 such that the virtual selfie image 214 is created real-time to the perception of user. According to this embodiment, image processing instructions read and adjust self image data, such as facial recognition, distance to object analysis, object recognition, tone, brightness, color, and other visual aspects discussed herein are conducted on the self image as the user is positioning device 100 to capture the desired image from camera 302, at 610 and 620. Moreover, the self image data is displayed on screen 204 with the image in field of view of camera 302 while the user is framing desired image, at 630. Thus, the user can visually see themself in the desired image that will become virtual selfie 214 upon instructing device 100 to capture the image, at 650.

According to another preferred embodiment of the present invention, as depicted in FIG. 6, virtual selfie application 400 executes instructions to operate user facing camera 202 simultaneously, or virtually simultaneous to the user, and desired image facing camera 302 such that the virtual selfie image 214 is created real-time to the perception of user. According to this embodiment, image processing instructions read and adjust self image data, at 610, 620 and as described elsewhere herein, but also adjust the self image of user being acquired by user facing camera 202 with respect to size and position of other individuals that are in the field of view of the desired image being framed by user through desired image camera 302, at 640. As such, at 640, virtual selfie application 400 reads and recognizes the individuals in the foreground of desired image, as described elsewhere herein, and adjusts self image data being captured from user facing camera 202 such that the image of user appears visually in the desired image 214 along with and matching in size, shape, and visual effects the images of individuals in the foreground of the desired image. Moreover, the self image data is displayed on screen 204 with the image in field of view of camera 302 while the user is framing the desired image, at 640. Thus, the user can visually see themself in the desired image, along with their subjects, whether friends, family, pet, or other object in the foreground to a desired image background, that will become virtual selfie 214 upon instructing device 100 to capture the desired image, at 650.

Each of the above identified instructions and applications can correspond to a set of instructions for performing one or more functions described above. These instructions need not be implemented as separate software programs, procedures, or modules. The memory can include additional instructions or fewer instructions. Furthermore, various functions of the computing device 100 can be implemented in hardware and/or in software, including in one or more signal processing and/or application specific integrated circuits.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller” or processor. The modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

Although illustrative example embodiments have been described herein with reference to the accompanying figures, it is to be understood that this description is not limiting and that various other changes and modifications may be affected therein by one skilled in the art without departing from the scope or spirit of the disclosure.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts. As used herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

1. A method of improving safety of selfie photography, comprising: obtaining self image data of a user using a first camera positioned on a first side of an electronic device;
obtaining desired image data using a second camera positioned on an opposite side of the electronic device facing a desired image to be acquired, and;
visually presenting the self image data acquired from the first camera with the desired image data on a display screen such that the desired image data includes the self image data to create a virtual selfie of the user in the desired image.

2. The method of claim 1, further comprising measuring visual components of the self image data and the desired image data, and adjusting the visual components of the self image data to match the visual components of the desired image, wherein the visually presented self image with the desired image visually appears to have been acquired in a single image.

3. The method of claim 1, further comprising measuring a distance form the first camera to the self image of the self image data, measuring a distance from the second camera to the desired image, calculating relative adjustments to the size of the self image data and adjusting the self image data such that the self image visually appears to have been acquired in a single image in the foreground of the desired image.

4. The method of claim 1, further comprising measuring visual components in the foreground of desired image data for image data to adjust the self image data against, and adjusting the visual components of the self image data to match the foreground visual components of the desired image, wherein the visually presented self image with the desired image visually appears to have been acquired in a single image.

5. The method of claim 4, wherein the measured foreground components include friends, family, pets, or other user desired objects to be included in the virtual selfie.

6. The method of claim 1, further comprising maintaining the self image data adjustable after visually presenting the self image data with the desired image data such that the user can move the self image data to position it within the desired image as desired.

7. The method of claim 1, further comprising maintaining the self image data adjustable after visually presenting the self image data with the desired image data such that the user can adjust size of the self image data to proportion it within the desired image as desired.

8. The method of claim 1, further comprising displaying the self image data on a display screen while the desired image data is being obtained and displayed on the display screen, wherein the display screen is visible to the user of the electronic device while the self image data and desired image data are obtained and displayed on to the user on the display screen.

9. The method of claim 1, further comprising storing the virtual selfie in the storage medium.

10. The method of claim 1, further comprising requiring the user to face their desired image to capture the desired image data with the second camera on the second side of the device facing away from the user while simultaneously capturing the self image data of the user with the first camera on the first side of the device facing the user, thereby increasing the safety of the user seeking a selfie by creating a virtual selfie by imposing the self image data onto the desired image data.

11. The method of claim 1, wherein the processor includes instructions to a. perform facial recognition and adjust the aperture and focal length of the first camera to primarily capture the self image of the user; b. extract the self image from the image captured by the first camera to generate the self image data; and adjust the self image data to visually fit with the desired image data such that a virtual selfie is created.

12. The method of claim 11, wherein the adjusting of the self image data to visually fit with the desired image data adjusts the lighting, shading, tone, texture, crispness, softness, or size of the self image data such that the virtual selfie appears to be a single image of the user taken in front of the desired image.

13. A device for improving safety of self photography, comprising:
a housing configured to house at least two cameras, a display screen, a processor and storage medium; wherein,
a first camera of the at least two cameras is configured on a first side of the housing and a second camera of the at least two cameras is configured on a second side of the housing, said second side of the housing configured opposite the first side of the housing, the display screen disposed on the first side of the housing and configured to face a user of the device, and wherein the processor comprises instructions to simultaneously process image data captured by the at least two cameras and the storage medium stores program instructions accessible by the processor and image data captured by the at least two cameras.

14. The device of claim 13, further comprising the processor processing instructions to capture self image data of the user by the first camera on the first side of the housing and desired image data of a desired image by the second camera on the second side of the housing, and processing the self image data and the desired image data to merge the self image data into the desired image data and simultaneously display the self image data and the desired image data on the display screen.

15. The device of claim 13, wherein the processor processes the self image data and visually positions the self image data on the desired image data to generate a virtual selfie.

16. The device of claim 13, wherein the self image data is manipulable such that the user can configure, move and dimension the self image data within the desired image data to generate a desired virtual selfie.

17. A system for enabling safe selfie photography, comprising:
a memory area associated with a computing device, the memory area including an operating system and one or more applications; and a processor that executes to:
identify a self image in a first camera of the computing device and capture the self image as self image data;
identify a desired image in a second camera of the computing device and capture the desired image as desire image data; and,
display the desired image data on a display screen of the computing device and visually overlay the self image data on the desired image data on the display screen;
and, storing the virtual selfie in the memory.

18. The system of claim 17, further comprising maintaining the self image data separate from the desired image data such that the user can manipulate the self image with respect to the desired image to make a virtual selfie.

19. The system of claim 17, wherein the processor further executes to recognize the user and select the user as the self image data and prompt the user to select safe selfie processing.

20. The system of claim 17, wherein the processor further executes to edit the self image data to match image characteristics of the desired image such that the self image data visually appears to have been acquired from the second camera when the second camera acquired the desired image data.
